(19) United States
(12) Patent Application Publication
(10) Pub. No.: US 2005/0259322 A1
(43) Pub. Date: Nov. 24, 2005

(54) Touch-enabled projection screen incorporating vibration sensors

(76) Inventors: James A. Boecker, Menomonie, WI (US); Anthony L. Hill, River Falls, WI (US); Michael J. Robrecht, Shorewood, WI (US)

Correspondence Address: 3M INNOVATIVE PROPERTIES COMPANY, PO BOX 33427, ST. PAUL, MN, 55133-3427, US

(21) Appl. No.: 10/850,324

(22) Filed: May 20, 2004

(51) Int. Cl. G03B 21/56

(52) U.S. Cl. 359/460

(57) ABSTRACT

The present invention provides a rear projection screen that has a light directing element coupled to a support layer. The light directing element directs an image toward a viewer position. The support layer provides the front surface of the projection screen, accessible to a user. Vibration sensors are mechanically coupled to the support layer to sense vibrations indicative of a touch to the front surface. The sensed vibrations are converted into signals that can be communicated to controller electronics to determine information related to the touch input, such as touch input location, touch force, touch implement type, and so forth.

The present invention relates to touch-sensitive projection screens, and to vibration-sensitive touch sensors.

### BACKGROUND

Electronic displays are widely used in all aspects of life. Although in the past the use of electronic displays has been primarily limited to computing applications such as desktop computers and notebook computers, as processing power has become more readily available, such capability has been integrated into a wide variety of applications. For example, it is now common to see electronic displays in a wide variety of applications such as teller machines, gaming machines, automotive navigation systems, restaurant management systems, grocery store checkout lines, gas pumps, information kiosks, and hand-held data organizers to name a few.

### SUMMARY OF THE INVENTION

The present invention provides an optical device that includes a rear projection screen for displaying a projected image, the rear projection screen having a support layer providing a front surface accessible from a viewer position and a light directing element coupled to a back surface of the support layer. The present invention further provides a plurality of vibration sensors mounted on the support layer of the rear projection screen, the vibration sensors configured to sense vibrations propagating in the projection screen indicative of a touch input to the front surface. Signals derived from the sensed vibrations can be communicated to controller electronics for determining information related to the touch input.

The present invention further provides a rear projection screen system that includes a projector engine, and a screen assembly that includes a rear projection screen incorporating a light directing element coupled to a back surface of a support layer, the support layer providing a front surface accessible from a viewer position, and the light directing element oriented to direct light from the projector engine toward the viewer position. A plurality of vibration sensors are mounted on the support layer and are configured to sense vibrations propagating in the projection screen indicative of a touch input to the front surface. Signal lines are electrically connected to the vibration sensors for communicating with controller electronics that are configured to determine information related to the touch input from signals derived from the vibrations sensed by the vibration sensors.

The present invention also provides a method of making a touch-enabled rear projection screen. The method includes providing a rear projection screen comprising a support layer that provides a front surface accessible from a viewer position, and a light directing element coupled to a back surface of the support layer. The method further includes mechanically coupling a plurality of vibration sensors to the support layer, the vibration sensors configured to detect vibrations indicative of a touch input to the front surface of the support layer. The method also includes routing signal lines from each of the plurality of vibration sensors, the signal lines configured to communicate signals derived from vibrations sensed by the vibration sensors to controller electronics for determining information related to the touch input.

### BRIEF DESCRIPTION OF THE DRAWINGS

The invention may be more completely understood in consideration of the following detailed description of various embodiments of the invention in connection with the accompanying drawings, in which:

FIG. 1 schematically shows a side view of a display system that includes a touch-enabled rear projection screen according to the present invention; and

FIG. 2 schematically shows a projection system that includes a touch-enabled rear projection screen according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention provides a touch-enabled rear projection screen that integrates vibration sensors coupled to a support layer having a front surface accessible to a user for interaction with the projection screen. The vibration sensors detect vibrations in the support layer that are indicative of a touch to the front surface. The vibrations can be those caused directly by the touch input, or can be vibrations propagated through the support layer that are altered due to interacting with the touch implement during a touch event, for example by reflection or absorption of the propagated vibrations. The detected vibrations indicative of the touch can be used to determine information related to the touch, such as touch position, touch force, whether the touch implement is a relatively soft or hard object, and the like.

Methods for determining information about a touch from vibrations caused or altered by the touch are disclosed in International Publications WO 01/48684 and WO 03/005292, European Patent EP 1 240 617 B1, U.S. patent applications Ser. No. 10/729,540, U.S. Ser. No. 10/750,290, U.S. Ser. No. 10/750,291 and U.S. Ser. No. 10/750,502, U.S. Patent Publications US 2003/0066692 and US 2002/0135570, and U.S. Pat. No. 5,637,829, all of which are incorporated into this document as if reproduced in full. Briefly, when a vibration signal due to a touch is received by the vibration sensors, time differentials for signal detection between the various pairs of vibration sensors can be used to determine the position of the touch. Phase difference information can also be used. Because vibrations indicative of a touch input generally include bending wave vibrations that are susceptible to dispersion during propagation, it may be desirable to correct for dispersion effects that may otherwise give rise to errors in the input position or other determined information. Exemplary methods for correcting for dispersion effects are disclosed in previously referred to document WO 01/48684. Touch force can be determined using signal amplitude information. Touch implement type can be determined by analyzing the frequencies present in the vibration signal.

According to the present invention, vibration sensors can be mechanically coupled to the front support layer of a rear projection screen in a manner that does not substantially interfere with the optical path of the displayed image, therefore having little or no adverse impact on brightness, contrast, viewing angle, or other properties of interest. As such, touch input capability can be achieved in a rear projection screen without needing an additional layer or overlay in the viewable area for touch sensing capability, which would be the conventional approach. In addition, the vibration sensors can be mounted to either the front or back surface of the support layer, and as such the front surface of the projection screen can be kept flat and free of active elements such as surface acoustic wave emitters, reflectors, and detectors that are employed in some acoustic wave touch screens. These factors can have benefits for display aesthetics, durability and ease of integration.

In exemplary embodiments, the present invention employs three or more vibration sensors, for example one vibration sensor mounted in each of the corners of a rectangular screen. Essentially the same or similar vibration sensors can be used regardless of the size of the screen. As such, the cost of integrating touch capability depends much less on the size of the screen as compared to conventional approaches. Signal lines can be printed or otherwise routed to each of the vibration sensors for communication with controller electronics. Exemplary layouts for vibration sensors and signal lines are disclosed in co-assigned U.S. patent application Ser. No. 10/440,650, which is fully incorporated into this document. The signal lines can be connected to a flex tail, or otherwise grouped to allow for simple connection to other components.

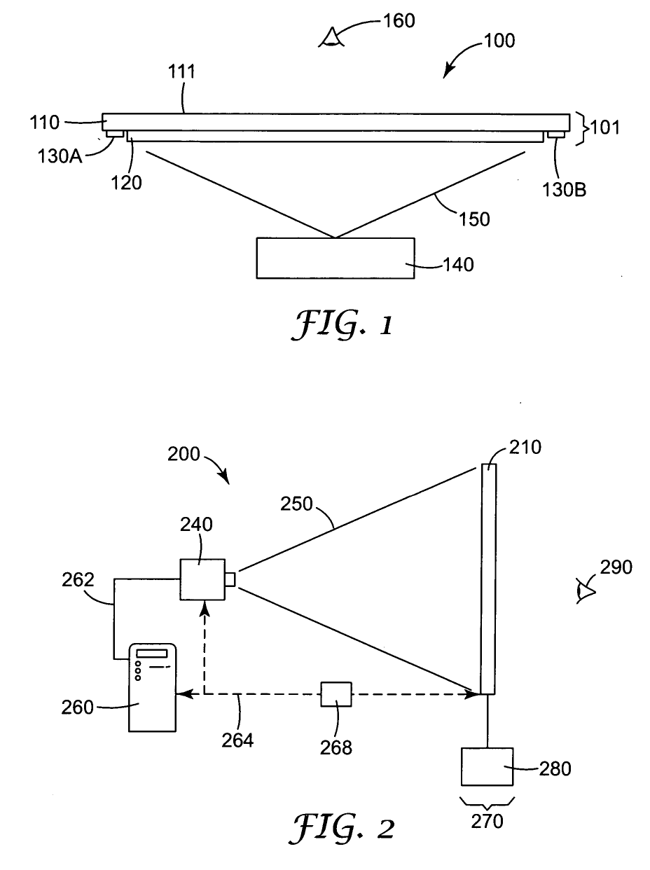

FIG. 1 shows a display system 100 that includes a rear projection screen 101 and a projector engine 140 that projects an image 150 onto the screen 101 for display to a viewer position 160. While the details are not shown, the path from the projector engine 140 to the screen 101 can be direct or folded, and can include any number of optical components such as lenses, mirrors, beam splitters, prisms, and so forth. The rear projection screen 101 includes an image directing element 120 coupled to a support layer 110 that provides a front surface 111 of the screen 101. Vibration sensors 130A and 130B are coupled to the support layer 110 and configured to detect vibrations propagating in the support layer due to a touch input to the front surface 111 of the support layer. Although only two vibration sensors are visible in the side view shown in FIG. 1, at least three sensor are needed to detect the location of a touch inputs in two dimensions on the screen. Fewer than three sensors may be utilized to determine other information related to the touch, such as impact force or touch implement type. While mounting the vibration sensors on the back of the support layer (as shown) may be desirable for aesthetic considerations, easy of integration, or other reasons, the vibrations sensors can also be mounted on the front surface of the support layer.

Rear projection screen 101 can be any suitable rear projection screen including those that contain lenticular elements, Fresnel lenses, microstructured waveguides, microbeads, and the like. An exemplary rear projection screen is a beaded rear projection screen available under the trade designation eXtended Resolution Video Screen (XRVS) from 3M Company. Examples of rear projection screens that may be utilized in the present invention include those disclosed in U.S. Pat. Nos. 4,418,986; 4,439,027; 4,490,010; 4,502,755; 4,573,764; 5,005,945; 5,020,877; 5,066,099; 5,432,636; 5,760,955; 5,870,224; 6,163,402; 6,185,038; 6,239,907; 6,466,368; 6,567,215; 6,634,756; and 6,636,355, all of which are incorporated into this document.

The image directing element 120 generally functions to direct the light from the projector engine 140 toward the viewing position 160. The image directing element 120 can include optical elements such as beads or waveguides (not indicated) that collect the light 150 from the projector engine 140 and direct it through apertures toward the viewing position 160. The image directing element can also include a contrast enhancement layer for absorbing ambient light that would otherwise tend to reduce contrast. For example, beads or waveguides may be embedded in or surrounded by a black, or other light absorbing, material so that the black material fills the interstices between apertures through which the projected image is displayed to the viewer. The image directing element can also include other optical films or elements such as turning films, prismatic films, diffuser elements, color shifting films, and the like, for managing the light from the projector engine by changing the angle of the light, the spread of the light, etc. Alternatively, other optical elements such as lenses, turning films, beam splitters, beam combiners, brightness enhancement films, polarization elements, antireflective films, mirrors, or any other desirable optical elements alone or in combination can be placed in any desirable position in the image path between the projector and the screen, as is well appreciated in the art.

Support layer 110 can be any material suitable for providing the front surface of a rear projection screen, and that is capable of supporting vibrations indicative of a touch input to its surface, the vibrations being detectable by piezoelectric devices or other vibration sensors mounted on a surface of the support layer to thereby determine information related to the touch input. Exemplary support layers can include polycarbonate, acrylates, glass, or other rigid or semi-rigid transparent materials, composites, or laminates. The support layer can include a bulk diffuser and/or a matte surface to provide antiglare properties, reduced speckle, and so forth. A matte surface may also provide a textured surface sufficient to cause detectable vibrations in the support plate when a touch implement is dragged across the surface, allowing for more reliable detection of touch input movement.

The image directing element can be laminated, adhered, bonded, or otherwise mated directly to the support layer, or can be coupled to the support layer through one or more other layers. Preferably, any adhesive or other layers disposed between the support layer and the light directing element have desirable optical properties, such as transparency and refractive index.

The vibration sensors can be any suitable devices capable of detecting vibrations propagating through the support plate, the vibrations being caused by or affected by touch inputs. Piezoelectric devices can provide sufficient functionality, for example those disclosed in co-assigned U.S. patent application Ser. No. 10/739,471, which is fully incorporated into this document. Aside from passive sensing of vibrations, vibration sensors can be used to emit vibrations into the support layer. The emitted vibrations can be used for touch detection, calibration and diagnostics, lift-off detection, or the like. Sensors can be used in dual sensing and emitting modes, or each can be dedicated to a single function. In addition, at least one sensor can be used to monitor noise signals, for example from external vibrations, which can then be cancelled from the touch signal by the controller electronics. Vibration sensors can be mounted or otherwise mechanically coupled to the support layer by any suitable means, including using various epoxies. It is also possible to arrange piezoelectric devices so that the electrodes can be accessed at the same surface of the devices, allowing the devices to be mechanically bonded and electrically coupled to signal lines at the same interface, and potentially with the same conductive adhesive, for example as disclosed in previously referred-to applications U.S. Ser. No. 10/739,471 and U.S. Ser. No. 10/440,650.

Projector engine 140 can be any suitable projector engine, and may include any suitable type of image display device including one or more cathode ray tubes, liquid crystal displays, microdisplays, and the like. The projector engine may also include a light engine that directs red, green, or blue light onto an array of adjustable micro-mirrors. System 100 can be an integrated, enclosed projection system similar to the cabinet systems disclosed in U.S. Pat. Nos. 4,439,027 and 4,621,293, which are incorporated into this document, or can be a system where the projector and screen are separate items similar to the system disclosed in U.S. Pat. No. 5,033,843, which is incorporated into this document.

It may be desirable to mount the screen 101 in the system so that the screen is substantially isolated from external vibrations and/or so that vibrations propagating in the support layer are absorbed at the edges of the screen to reduce reflections of the vibrations. This may be accomplished by utilizing a foam tape or similar material around the edges of the screen. Exemplary materials include acrylic foam tapes, double-coated adhesive tapes such as those sold by 3M Company under the trade designations 3M 4956 and 3M 5962, urethane foam tapes, single-coated tapes such as those sold by 3M Company under the trade designation 3M 4314, and the like. Other materials that may be suitable include various urethanes and silicones, as well as visco-elastic materials useful for vibration damping applications.

The present invention can lend itself to applications where portability is a desirable feature. FIG. 2 shows a projection system 200 that includes a rear projection screen assembly 270 that includes a rear projection screen 210 mounted to a stand 280. Rear projection screen 210 includes an image directing element (not shown) coupled to a support layer that provides a front surface accessible to a viewer position 290, and vibration sensors (not shown) mounted to the support layer. Stand 280 provides support for the projection screen 210, and may allow for adjustment of the height, rotation angle, tilt, or other positioning of the projection screen. Stand 280 may also be provided with casters or fold-away legs for easy portability and/or storage.

Projection screen 210 directs image light 250 from projector 240 toward viewing position 290. Projector 240 can be connected by communications line 262 to a computer 260. Communications line 262 can be a physical connection such as a cable or fiber optic, or can be a remote link, such as through infrared data ports, or a combination of physical and remote communication. Communications line 262 can be internal to a device that includes both the computer and the projector, or can be an external link to separate computer and projector units. The computer and/or the projector can be included with the projection screen assembly, or can be provided as separate items.

The vibration sensors of the projection screen 210 communicate the measured vibration signals to controller electronics 268 for determination of information related to the event that caused the measured vibrations. The determined information, such as the position of a touch input, the force of the touch input impact, the type of touch implement, etc., can be communicated to the computer 260, to the projector 240, or both so that instructions can be carried out and/or the displayed information can be modified accordingly. The controller electronics 268 can reside on the projection screen 210, on the projection screen assembly 270, within the computer 260, within the projector 240, elsewhere as a stand alone unit (not shown), or various components that make up the controller electronics can be placed in combinations of these locations. Communications between the controller electronics and the other components including the vibration sensors, the computer and/or the projector, can take place via physical connections, remote linking, or both along communications line 264.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

1. An optical device, comprising:
a rear projection screen for displaying a projected image, the rear projection screen comprising a support layer providing a front surface accessible from a viewer position and a light directing element coupled to a back surface of the support layer; and
a plurality of vibration sensors mounted on the support layer and configured to sense vibrations propagating in the projection screen indicative of a touch input to the front surface and to communicate signals derived from the sensed vibrations to controller electronics for determining information related to the touch input from the communicated signals.

2. The optical device of claim 1, further comprising a projector oriented to project an image that is directed by the light directing element toward the viewer position.

3. The optical device of claim 1. further comprising a stand supporting the rear projection screen.

4. The optical device of claim 3, wherein the stand allows for positional adjustment of the rear projection screen.

5. The optical device of claim 3, wherein the stand is movable.

6. The optical device of claim 1, further comprising one or more optical elements disposed to direct light from a display device to the light directing element for directing toward the viewer position.

7. The optical device of claim 6, wherein the one or more optical elements comprise one or more mirrors.

8. The optical device of claim 6, wherein the one or more optical elements comprise one or more lenses.

9. The optical device of claim 6, wherein the one or more optical elements comprise one or more optical films coupled to the light directing element.

10. The optical device of claim 1, further comprising vibration damping material coupled to the rear projection screen.

11. The optical device of claim 1, wherein the support layer comprises an acrylic plate.

12. The optical device of claim 1, wherein the support layer comprises a polycarbonate plate.

13. The optical device of claim 1, wherein the support layer comprises glass.

14. The optical device of claim 1, wherein the support layer comprises a laminate.

15. The optical device of claim 1, wherein the front surface of the support layer is a matte surface.

16. The optical device of claim 1, wherein the support layer incorporates a bulk diffuser.

17. The optical device of claim 1, wherein the light directing element comprises a plurality of waveguides.

18. The optical device of claim 1, wherein the light directing element comprises a lenticular element.

19. The optical device of claim 1, wherein the light directing element comprises a Fresnel lens.

20. The optical device of claim 1, wherein the light directing element comprises microbeads.

21. The optical device of claim 1, wherein the light directing element comprises a light absorbing material filling the interstices between a plurality of apertures through which light is directed toward the viewer position.

22. The optical device of claim 1, wherein the vibration sensors are mounted on the front surface of the support layer.

23. The optical device of claim 1, wherein the vibration sensors are mounted on the back surface of the support layer.

24. The optical device of claim 1, wherein the vibration sensors comprise piezoelectric devices.

25. The optical device of claim 1, wherein the plurality of vibration sensors comprise four vibration sensors.

26. The optical device of claim 25, wherein the support layer is rectangular, and the four vibration sensors are mounted one in each corner of the support layer.

27. The optical device of claim 1, further comprising the controller electronics.

28. A rear projection screen system, comprising:
a projector engine;
a screen assembly comprising a rear projection screen comprising a light directing element coupled to a back surface of a support layer, the support layer providing a front surface accessible from a viewer position, and the light directing element oriented to direct light from the projector engine toward the viewer position;
a plurality of vibration sensors mounted on the support layer and configured to sense vibrations propagating in the projection screen indicative of a touch input to the front surface;
signal lines electrically connected to the vibration sensors; and
controller electronics in electrical communication with the signal lines and configured to determine information related to the touch input from signals derived from the vibrations sensed by the vibration sensors.

29. The system of claim 28, wherein the controller electronics are physically coupled to the signal lines.

30. The system of claim 28, wherein the controller electronics are remotely coupled to the signal lines.

31. The system of claim 28, wherein the controller electronics are in electrical communication with the projector engine.

32. The system of claim 31, wherein the controller electronics communicate with the projector engine through a computer.

33. The system of claim 28, wherein the controller electronics are located on the screen assembly.

34. The system of claim 28, wherein the controller electronics are located in a computer separated from the screen assembly.

35. A method of making a touch-enabled rear projection screen comprising:
providing a rear projection screen comprising a support layer that provides a front surface accessible from a viewer position, and a light directing element coupled to a back surface of the support layer;
mechanically coupling a plurality of vibration sensors to the support layer, the vibration sensors configured to detect vibrations indicative of a touch input to the front surface of the support layer;
routing signal lines from each of the plurality of vibration sensors, the signal lines configured to communicate signals derived from vibrations sensed by the vibration sensors to controller electronics for determining information related to the touch input.
